(19) United States
(12) Patent Application Publication
(10) Pub. No.: US 2011/0174075 A1
(43) Pub. Date: Jul. 21, 2011

(54) ACCELERATION SENSOR AND ACCELERATION DETECTING APPARATUS

(75) Inventors: Jun WATANABE, Matsumoto (JP); Kazuyuki NAKASENDO, Shiojiri (JP)

(73) Assignee: SEIKO EPSON CORPORATION, Tokyo (JP)

(21) Appl. No.: 12/985,554

(22) Filed: Jan. 6, 2011

(30) Foreign Application Priority Data
Jan. 18, 2010 (JP) 2010-007860

(51) Int. Cl. G01P 15/09

(52) U.S. Cl. 73/514.34

(57) ABSTRACT

An acceleration sensor includes a piezoelectric sensor and a support plate including a first support surface and a second support surface for supporting the piezoelectric sensor, wherein the support plate includes a first plate piece, a second plate piece, and a hinge portion connecting opposite side edges of the first plate piece and the second plate piece, wherein the piezoelectric sensor element has a longitudinal shape extending in a direction perpendicular to the sensing axis direction and is separated from the support surfaces in the longitudinal direction of the hinge portion so that the center of the sensor element in the lateral direction is located within the width of the hinge portion in the lateral direction.

### BACKGROUND

1. Technical Field

The present invention relates to an acceleration sensor and an acceleration detecting apparatus, and more particularly, to an acceleration sensor and an acceleration detecting apparatus, which can be improved to change a direction of a force resulting from an applied acceleration and to enhance the force.

2. Related Art

An acceleration sensor employing a piezoelectric vibration element is configured to change a resonance frequency of the piezoelectric vibration element and to detect an acceleration applied to the acceleration sensor from the change in resonance frequency, when a force in a sensing axis direction is applied to the piezoelectric vibration element.

Japanese Patent No. 2851566 discloses an acceleration meter and a manufacturing method thereof, in which a double-ended tuning fork type vibration element is bonded to a pair of opposite angles of a parallelogram frame and a compressing force or a stretching force is applied to the other pair of opposite angles.

As shown in the sectional view of FIG. 7, the acceleration meter is configured to couple a mass 116 moving along a sensing axis 119 to a support 117 with a curved portion 118. A pair of force-sensing crystals 121 and 122 connected between the mass 116 and the support 117 is changed in frequency depending on the force applied thereto. The force-sensing crystals 121 and 122 are excited by frequency oscillators 123 and 124, the signals from the two oscillators are input to an adder circuit 126, and an output signal corresponding to a difference between two frequencies is output therefrom.

In the acceleration meter, five disk-like elements formed of crystal (quartz crystal) and the like are stacked along the sensing axis. That is, the acceleration meter includes a central element 127 shown in FIGS. 8A and 8B, a pair of transducer elements 128 disposed on both sides of the central element 127 and shown in FIG. 9, and a pair of covers (not shown) disposed on both outer sides of the transducer elements 128. Here, FIG. 8A is a plan view of the central element 127 and FIG. 8B is a sectional view taken along line VIIIB-VIIIB.

As shown in FIGS. 8A and 8B, the central element 127 includes a fixed portion 134 and a movable portion (vibrating mass) 133 having a mass. The movable portion 133 is connected to the fixed portion 134 by a pair of curved portions 136 so as to move around a hinge axis 137 extending perpendicular to the sensing axis. The movable portion 133 and the fixed portion 134 are disposed inside a mounting ring 139 on which the fixed portion 134 is mounted. A partition ring 141 is coaxially disposed outside the mounting ring 139, and a flexible arm connects the mounting ring 139 to the partition ring 141. The central element has a one-body structure.

The transducer element 128 includes a mounting ring 146 as shown in the plan view of FIG. 9, and a force-sensing element (crystal) 147 and a coupling plate 148 are disposed therein. The force-sensing element 147 includes a double-ended tuning fork type piezoelectric vibration element 151 connected to a pair of opposite angles of a quadrilateral frame 149 including four links 152 and pads 154 and 156 at the other pair of opposite angles. One pad 154 is formed in a body with the coupling plate 148 and the other pad 156 is formed in a body with the mounting ring 146.

The coupling plates 148 of the two transducer elements 128 are coupled to both main surfaces 138 of the movable portion 133 of the central element 127 with an adhesive, and the mounting rings 146 of the transducer elements are connected to the mounting ring 139 of the central element 127 with an adhesive.

The two covers have a circular shape having a recession on one side and have a closed structure. Gas is injected into the covers, which also serves as a braking plate. The recessions face the transducer elements 128 and the peripheries of the covers are bonded to the mounting rings 146 of the transducer elements 128 with an adhesive.

However, the acceleration meter disclosed in Japanese Patent No. 2851566 includes one central element 127, two transducer elements 128, and two covers and thus has a problem in that the number of components is great. The central element 127 and the transducer elements 128 have very complex structures and the yield ratios of the elements are considered as being low. In addition, there is a problem in that a large number of processes are necessary for adjusting the assembled acceleration meter and the cost of the acceleration meter is very high.

Since braking gas is enclosed in the acceleration meter, there is a problem in that the Q value of the vibration element 151 of the transducer element 128 is deteriorated and it is thus difficult to excite the vibration element.

### SUMMARY

An advantage of some aspects of the invention is that it provides an acceleration sensor and an acceleration detecting apparatus, which has a simple structure and high acceleration detecting performance and can reduce the manufacturing cost thereof.

The invention can be implemented as the following forms or application examples.

### Application Example 1

An acceleration sensor of this application example includes a piezoelectric sensor and a support plate including a first support surface and a second support surface for supporting the piezoelectric sensor. Here, the piezoelectric sensor includes a piezoelectric sensor element generating an electrical signal corresponding to a force in a sensing axis direction, a first fixed portion and a second fixed portion fixed to the first support surface and the second support surface, respectively, to support the piezoelectric sensor element on the support plate, and first to fourth beams connecting the piezoelectric sensor element to the first fixed portion and the second fixed portion. The support plate includes a fixation-side first plate piece having the first support surface for fixing the first fixed portion, a movement-side second plate piece being arranged parallel to the in-plane direction of the first support surface and having the second support surface for supporting the second fixed portion, and a hinge portion connecting opposite side edges of the first plate piece and the second plate piece so as to allow the second plate piece to move in the thickness direction. The piezoelectric sensor element has a longitudinal shape extending in a direction perpendicular to the sensing axis direction and is separated from the support surfaces in the longitudinal direction of the hinge portion so that the center of the sensor element in the lateral direction is located within the width of the hinge portion in the lateral direction. The first beam connects the first fixed portion to an end of the piezoelectric sensor element in the longitudinal direction, the second beam connects the first fixed portion to the other end of the piezoelectric sensor element in the longitudinal direction, the third beam connects the second fixed portion to an end of the piezoelectric sensor element in the longitudinal direction, and the fourth beam connects the second fixed portion to the other end of the piezoelectric sensor element in the longitudinal direction.

In this way, the support plate includes the flat panel-like first plate piece on the fixation side, the flat panel-like second plate piece on the movement side, and the hinge portion connecting both to each other. The piezoelectric sensor has a structure in which the first to fourth beams form a parallelogram frame, the first fixed portion and the second fixed portion are disposed at a pair of opposite angles, and the piezoelectric sensor element is connected to the other pair of opposite angles. Accordingly, it is possible to form the support plate and the piezoelectric sensor with good dimensional precision by using a flat panel-like piezoelectric plate as both plate pieces and applying a photolithography technique and an etching technique as well as to mass-produce an acceleration sensor with a small size and at a low cost therewith. In the acceleration sensor, since the frame formed by the first to fourth beams changes the direction of the force caused by the application of an acceleration by 90 degrees and enhances the force, it is possible to detect a small acceleration (with high sensitivity) and to obtain an acceleration sensor with high detection precision and reproducibility.

### Application Example 2

This application example is directed to the acceleration sensor according to Application Example 1, wherein the first to fourth beams each have a thin band shape with the same width allover the length as viewed in a direction perpendicular to the first support surface and the second support surface.

By forming the first to fourth beams in a thin band shape with the same width, it is possible to improve the transmission efficiency of the force caused by the application of an acceleration and to detect a small acceleration with good reproducibility.

### Application Example 3

This application example is directed to the acceleration sensor according to Application Example 1 or 2, wherein the first plate piece, the second plate piece, and the hinge portion are formed in a body and the first support surface of the first plate piece and the second support surface of the second plate piece are flush with each other.

By forming the first plate piece, the second plate piece, and the hinge portion in a body with the piezoelectric plate using the photolithography technique and the etching technique, it is possible to form the elements with high dimensional precision and to improve the detection sensitivity of the acceleration sensor, thereby improving the detection precision. The first support surface of the first plate piece and the second support surface of the second plate piece can be easily made to be flush with each other. It is also possible to minimize the deformation by bonding the support plate to the piezoelectric sensor and to improve the yield ratio of the acceleration sensor and the reproducibility of the detection precision.

### Application Example 4

This application example is directed to the acceleration sensor according to any one of Application Examples 1 to 3, wherein the position of the center in the lateral direction of the piezoelectric sensor element is matched with that of the center in the lateral direction of the hinge portion.

By substantially matching the center in the lateral direction of the piezoelectric sensor element with the center in the lateral direction of the hinge portion with each other, the sensitivity of the acceleration sensor (the variation in frequency of the piezoelectric sensor element when the same acceleration is applied thereto) is most improved.

### Application Example 5

This application example is directed to the acceleration sensor according to any one of Application Examples 1 to 4, wherein the first to fourth beams each have a straight line shape, and wherein an angle formed by the first beam and the second beam in the first fixed portion and an angle formed by the third beam and the fourth beam in the second fixed portion are obtuse angles.

By setting the angle formed by the first beam and the second beam and the angle formed by the third beam and the fourth beam to be obtuse, the angle formed by the first beam and the third beam and the angle formed by the second beam and the fourth beam are acute and it is thus possible to change the direction of the force applied to the second plate piece by 90 degrees and to enhance the magnitude of the force.

### Application Example 6

This application example is directed to the acceleration sensor according to any one of Application Examples 1 to 5, wherein the first to fourth beams each have an L shape, and wherein the first and second beams are connected in a U shape and the third and fourth beams are connected in a U shape.

By forming the first beam and the first fixed portion, the second beam and the first fixed portion, the third beam and the second fixed portion, and the fourth beam and the second fixed portion substantially in an L shape, connecting the first beam and the second beam in a U shape, and connecting the third and fourth beams in a U shape, it is possible to change the direction of the force applied to the second plate piece by 90 degrees and to enhance the magnitude of the force.

### Application Example 7

This application example is directed to the acceleration sensor according to any one of Application Examples 1 to 5, wherein the first to fourth beams each have a circular arc shape, and wherein the first and second beams are connected in one shape of a semi-circular shape, a semi-elliptical shape, and a semi-oval shape and the third and fourth beams are connected in one shape of a semi-circular shape, a semi-elliptical shape, and a semi-oval shape.

Since the first beam and the second beam, and the third beam and the fourth beam are formed in one shape of a semi-circular shape, a semi-elliptical shape, and a semi-oval shape, it is possible to change the direction of the force applied to the second plate piece by 90 degrees and to enhance the magnitude of the force.

### Application Example 8

This application example is directed to the acceleration sensor according to any one of Application Examples 1 to 7, wherein at least a part of the first fixed portion protrudes more to the outside from the beams than an intersection of the first and second beams and at least a part of the second fixed portion protrudes more to the outside from the beams than an intersection of the third and fourth beams.

Since the first fixed portion and the second fixed portion are formed to protrude more from the outside of the beams than the intersection of the first and second beams and the intersection of the third and fourth beams, it is possible to uniformly transmit the force applied to the second plate piece to the beams.

### Application Example 9

An acceleration detecting apparatus according to this application example includes: the acceleration sensor according to any one of Application Examples 1 to 8; and an IC that includes an oscillation circuit exciting the piezoelectric sensor element of the acceleration sensor, a counter counting an output frequency of the oscillation circuit, and a computing circuit processing the signal of the counter.

The acceleration sensor is constructed in which the support plate and the piezoelectric sensor are formed of a crystal plate and a double-ended tuning fork type crystal vibrating element is used as the piezoelectric sensor element. By constructing the acceleration detecting apparatus using the acceleration sensor and the IC having various functions, it is possible to implement an acceleration detecting apparatus with a greatly-improved acceleration detecting sensitivety and excellent detection precision, reproducibility, temperature characteristic, and aging characteristic.

### BRIEF DESCRIPTION OF THE DRAWINGS

The invention will be described with reference to the accompanying drawings, wherein like numbers reference like elements.

FIGS. 1A and 1B are diagrams schematically illustrating the structure of an acceleration sensor according to an embodiment of the invention, where FIG. 1A is a plan view and FIG. 1B is a sectional view.

FIGS. 2A, 2B, and 2C are diagrams illustrating a double-ended tuning fork type piezoelectric vibration element, where FIG. 2A is a plan view in a vibration mode, FIG. 2B is a diagram illustrating excitation electrodes formed in a vibration arm and signs of electrical charges generated at a certain moment, and FIG. 2C is a connection wiring diagram of excitation electrodes.

FIG. 3 is a diagram schematically illustrating the operation of a frame formed by first to fourth beams.

FIGS. 4A, 4B, and 4C are partial plan views illustrating positional relations of a piezoelectric sensor element and a hinge portion.

FIGS. 5A and 5B are diagrams schematically illustrating the structure of an acceleration sensor according to a second embodiment of the invention, where FIG. 5A is a plan view and FIG. 5B is a sectional view.

FIG. 6 is a block diagram illustrating the configuration of an acceleration detecting apparatus according to an embodiment of the invention.

FIG. 7 is a sectional view schematically illustrating the configuration of an acceleration meter according to the related art.

FIGS. 8A and 8B are diagrams illustrating the configuration of a central element of the acceleration meter according to the related art, where FIG. 8A is a plan view and FIG. 8B is a sectional view.

FIG. 9 is a plan view illustrating the configuration of a transducer element of the acceleration meter according to the related art.

### DESCRIPTION OF EXEMPLARY EMBODIMENTS

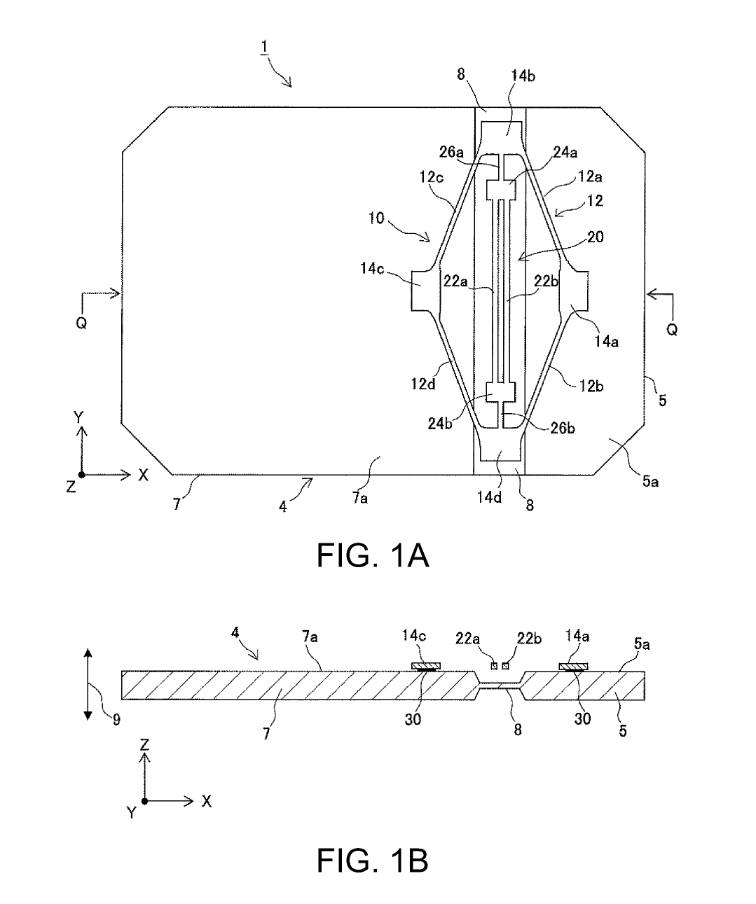

Hereinafter, exemplary embodiments of the invention will be described in detail with reference to the accompanying drawings. FIGS. 1A and 1B are diagrams schematically illustrating the configuration of an acceleration sensor 1 according to an embodiment of the invention, where FIG. 1A is a plan view and FIG. 1B is a sectional view taken along line IB-IB. The acceleration sensor 1 includes a piezoelectric sensor 10 and a support plate 4 having a first support surface 5a and a second support surface 7a for supporting the piezoelectric sensor 10.

The piezoelectric sensor 10 includes a piezoelectric sensor element 20 generating an electrical signal corresponding to a force in a sensing axis direction 9 shown in FIG. 1B, a first fixed portion 14a and a second fixed portion 14c fixed to the first support surface 5a and the second support surface 7a, respectively, to support the piezoelectric sensor element 20 on the support plate 4, and first to fourth beams 12a, 12b, 12c, and 12d connecting the piezoelectric sensor element 20 to the first fixed portion 14a and the second fixed portion 14c.

As shown in FIG. 1B, the support plate 4 includes a first plate piece 5 on a fixation side, a second plate piece 7 on a movement side, and a hinge portion 8 connecting the first plate piece 5 and the second plate piece 7. That is, the support plate 4 includes the first plate piece 5 on a fixation side having a first support surface 5a to which the first fixed portion 14a of the piezoelectric sensor 10 is fixed, the second plate piece 7 on a movement side having a second support surface 7a disposed in parallel with the first support surface 5a in the in-plane direction (to the lateral in the drawing) so as to support the second fixed portion 14c, and the hinge portion 8 connecting the opposite side edges of the first plate piece 5 and the second plate piece 7 so as to allow the second plate piece to move in the thickness direction. The hinge portion 8 is formed with a thickness smaller than that of the first plate piece 5 and the second plate piece 7 and the hinge portion 8 can be bent. The sectional shape of the hinge portion 8 is one of a rectangular shape, a trapezoid shape, and a circular-arc shape and it is formed in at least one side in the thickness direction.

The first plate piece 5, the second plate piece 7, and the hinge portion 8 are formed in a body, and the first support surface 5a of the first plate piece 5 and the second support surface 7a of the second plate piece 7 are flush with each other.

The first to fourth beams 12a to 12d of the piezoelectric sensor 10 have a parallelogram-shaped or diamond-shaped frame (referred to as “frame 12”). The first fixed portion 14a and the second fixed portion 14c are disposed at one pair of opposite angles and a first base portion 14b and a second base portion 14d are disposed at the other pair of opposite angles. That is, the first beam 12a of the frame 12 connects the first fixed portion 14a and the first base portion 14b, and the second beam 12b connects the first fixed portion 14a and the second base portion 14d. The third beam 12c connects the second fixed portion 14c and the first base portion 14b, and the fourth beam 12d connects the second fixed portion 14c and the second base portion 14d, whereby the first to fourth beams 12a to 12d form a parallelogram-shaped frame.

The first fixed portion 14a and the second fixed portion 14c of the piezoelectric sensor 10 are fixed to the first support surface 5a and the second support surface 7a of the support plate 4, respectively, and transmit the movement of the second plate piece 7 to the piezoelectric sensor element 20 via the first beam to the fourth beam 12a to 12d.

The first to fourth beams 12a to 12d each have a straight line shape. The angle formed by the first beam 12a and the second beam 12b in the first fixed portion 14a and the angle formed by the third beam 12c and the fourth beam 12d in the second fixed portion 14c are obtuse. That is, the frame 12 in which the angle θ formed by the first beam 12a and the third beam 12c in the first base portion 14b and the angle θ formed by the second beam 12b and the fourth beam 12d in the second base portion 14d are acute changes the direction of a force applied to the first fixed portion 14a and the second fixed portion 14c by 90 degrees, enhances the magnitude of the force, and applies the force to the piezoelectric sensor element 20. The enhancement ratio of the force varies depending on the angle θ.

As viewed in the direction perpendicular to the first support surface 5a and the second support surface 7a, the first to fourth beams 12a to 12d each have a thin band shape with the same width all over the length.

The piezoelectric sensor element 20 is connected to the first base portion 14b and the second base portion 14d of the frame 12 by a first support piece 26a and a second support piece 26b, respectively, and is formed in a body with the frame 12 to form the piezoelectric sensor 10. The piezoelectric sensor element 20 has a thin longitudinal shape extending in the direction perpendicular to the sensing axis direction 9 of the acceleration sensor 1, and is disposed separated from the first support surface 5a and the second support surface 7a in the longitudinal direction of the hinge portion 8 so that the center in the lateral direction of the piezoelectric sensor element 20 is located within the width in the lateral direction of the hinge portion 8 of the support plate 4 at the time of supporting and fixing the first fixed portion 14a and the second fixed portion 14c of the piezoelectric sensor 10 to the first support surface 5a and the second support surface 7a of the support plate 4, respectively. Preferably, the center in the lateral direction of the piezoelectric sensor element 20 is substantially matched with the center in the lateral direction of the hinge portion 8.

At least a part of the first fixed portion 14a protrudes more to the outside of the beams than the intersection of the first and second beams 12a and 12b and at least a part of the second fixed portion 14c protrudes more to the outside of the beams than the intersection of the third and fourth beams 12c and 12d.

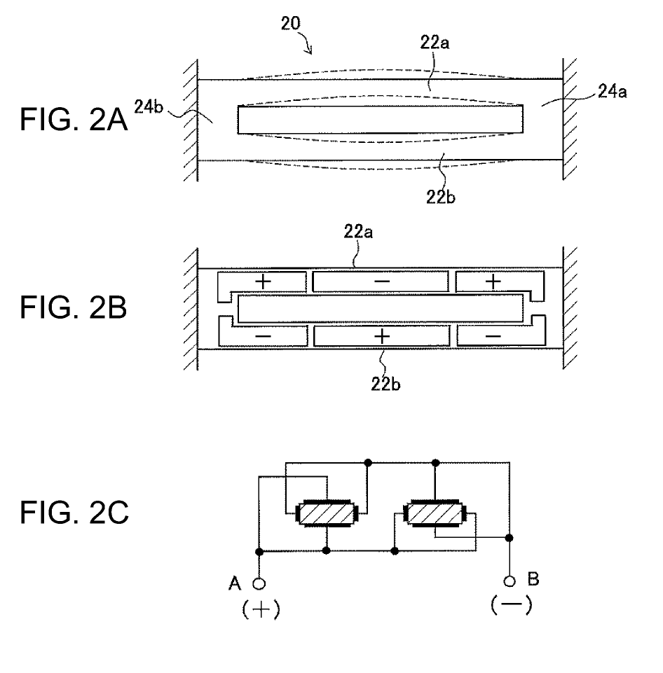

For example, as shown in FIG. 1A, a double-ended tuning fork type piezoelectric vibration element including a pair of vibration arms 22a and 22b and a pair of bases 24a and 24b is used as the piezoelectric sensor element 20. An example where the double-ended tuning fork type piezoelectric vibration element is used as the piezoelectric sensor element 20 will be described in brief with reference to FIGS. 2A, 2B, and 2C.

As shown in FIG. 2A, the double-ended tuning fork type piezoelectric vibration element 20 includes a stress sensing unit formed of a piezoelectric plate having a pair of bases 24a and 24b and a pair of vibration arms 22a and 22b connecting the bases 24a and 24b and excitation electrodes formed on a vibration area of the piezoelectric plate thereof. FIG. 2A is a plan view in which the broken lines represent vibration postures of the double-ended tuning fork type piezoelectric vibration element 20. The excitation electrodes are arranged so that the vibration mode of the double-ended tuning fork type piezoelectric vibration element 20 is symmetric about the center axis in the longitudinal direction of the pair of vibration arms 22a and 22b. FIG. 2B is a plan view illustrating the excitation electrodes formed on the vibration arms 22a and 22b and signs of electric charges on the excitation electrodes excited at a certain moment. FIG. 2C is a sectional view schematically illustrating the connection wiring of the excitation electrodes.

The double-ended tuning fork type piezoelectric vibration element 20, for example, a double-ended tuning fork type crystal vibration element, is excellent in sensitivity about stretching and compressing stresses and is excellent in resolution when it is used as a stress-sensitive element for an altimeter or a depth recorder. Accordingly, it is possible to obtain a height difference and a depth difference from a slight pressure difference.

The frequency-temperature characteristic of the double-ended tuning fork type crystal vibration element is a quadratic curve protruding to the upside and the peak temperature depends on a rotation angle about the X axis (electrical axis) of a crystalline crystal. In general, parameters are set so that the peak temperature is a normal temperature (25° C.)

The resonance frequency f_{F} when an external force F is applied to the pair of vibration arms of the double-ended tuning fork type crystal vibration element is expressed by Expression (1).

f_{F}=f₀(1−(KL²F)/(2EI))^{1/2} (1)

Here, f₀ represents the resonance frequency of the double-ended tuning fork type crystal vibration element when no external force is applied, K represents a constant (=0.0458) based on a basic wave mode, L represents the length of a vibration beam, E represents a longitudinal elastic modulus, and I represents a sectional second moment. Since the sectional second moment I is I=dw³/12, Expression (1) can be modified into Expression (2). Here, d represents the thickness of a vibration beam and w represents the width thereof.

f_{F}=f₀(1−S_{F}σ)^{1/2} (2)

Here, the stress sensitivity S_{F} and the stress σ are expressed as follows.

S_{F}=12(K/E)(L/w)² (3)

σ=F/(2A) (4)

Here A represents the sectional area (=w·d) of the vibration beam.

It is assumed in the above-mentioned expressions that the force F applied to the double-ended tuning fork type crystal vibration element is minus in the compressing direction and is plus in the stretching direction (extending direction). Then, in the relation of the force F and the resonance frequency f_{F}, the resonance frequency f_{F} decreases when the force F is the compressing force and increases when the force F is the stretching force (extending force). The stress sensitivity S_{F} is proportional to the square of L/w of the vibration beam.

The piezoelectric sensor element shown in FIGS. 1A and 1B is not limited to the double-ended tuning fork type crystal vibration element using the crystal plate, but may employ any vibration element as long as it is a vibration element of which the frequency varies depending on the stretching and compressing stresses. For example, a vibration element in which a driving unit is attached to a vibrating body, a single beam vibration element, a thickness-smoothed vibration element, and a SAW vibration element may be employed.

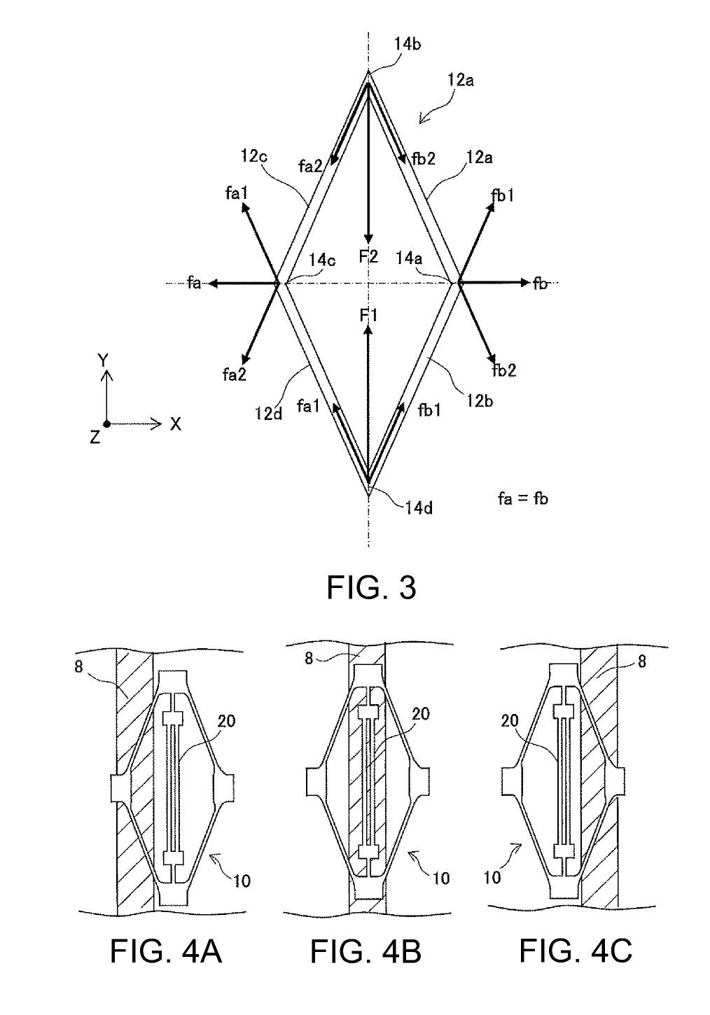

The operation of the frame 12 will be described with reference to the schematic diagram shown in FIG. 3. It is assumed that a force (vector) fa in the −X axis direction (to the left in the drawing) is applied to the second fixed portion 14c and a force (vector) fb in the +X axis direction (to the right in the drawing) is applied to the first fixed portion 14a. The force fa in the −X axis direction is divided into a force fa2 in the direction of the third beam 12c and a force fa1 in the direction of the fourth beam 12d by the vector parallelogram law, and the force fb in the +X axis direction is divided into a force fb2 in the direction of the first beam 12a and a force fb1 in the direction of the second beam 12b. The forces fa1, fa2, fb1, and fb2 applied to the second fixed portion 14c and the first fixed portion 14a are equivalent to the fact that the force fa2 in the direction of the third beam 12c and the force fb2 in the direction of the first beam are applied to the first base portion 14b of the frame 12 and the force fa1 in the direction of the fourth beam 12d and the force fb1 in the direction of the second beam 12b are applied to the second base portion 14d.

When the forces fa2 and fb2 applied to the first base portion 14b are combined by the law of parallelogram, the resultant force is a force F2. Similarly, when the forces fa1 and fb1 applied to the second base portion 14d are combined, the resultant force is a force F1.

The forces fa and fb applied to the first fixed portion 14a and the second fixed portion 14c of the frame 12 are equivalent to the forces F2 and F1 applied to the first base portion 14b and the second base portion 14d. That is, the frame 12 has a function of changing the direction of the force by 90 degrees and enhancing the magnitude of the force.

The operation of the acceleration sensor 1 according to the embodiment of the invention will be described. When an acceleration α in the direction (+Z axis direction) of the sensing axis 9 (Z axis) is applied to the acceleration sensor 1, a force F (=m×α, where m is the mass of the second support piece 7) acts on the second support piece 7 of the support plate 4 and the second support piece 7 is bent in the −Z axis direction from the hinge portion 8 by the force F. The first fixed portion 14a is fixed to the first plate piece supported by and fixed to a plate not shown. Accordingly, when the second support piece 7 is bent in the −Z axis direction, the force in the +X axis direction is applied to the first fixed portion. The force in the −X axis direction is applied to the second fixed portion 14c fixed to the second support piece 7. That is, the force f in the −X axis direction is applied to the second fixed portion 14c and the force f in the +X axis direction is applied to the first fixed portion 14a. When the forces f with the same magnitude in the opposite directions are applied in the X axis direction to the first fixed portion 14a and the second fixed portion 14c of the frame 12, the force F toward the center of the frame 12 is applied to the first base portion 14b and the second base portion 14d in the Y axis direction as shown in FIG. 3. A compressing force is applied to the piezoelectric sensor element 20 by the force F. For example, when the double-ended tuning fork type piezoelectric vibration element is used as the piezoelectric sensor element 20, the frequency is lowered.

When the acceleration α in the −Z axis direction is applied to the acceleration sensor 1, the second support piece 7 is bent in the +Z axis direction about the hinge portion 8 and a stretching force (extending force) is applied to the piezoelectric sensor element 20. When the double-ended tuning fork type piezoelectric vibration element is used as the piezoelectric sensor element 20, the frequency is raised.

It is possible to detect the direction of the acceleration α from the increase or decrease in frequency of the piezoelectric sensor element 20 and to detect the magnitude of the acceleration α from the variation in frequency.

FIGS. 4A, 4B, and 4C are partial plan views illustrating the relative positional relation of the hinge portion 8 of the support plate 4 and the piezoelectric sensor 10 supported by and fixed to the first plate piece 5 and the second plate piece 7, which are the main parts of the acceleration sensor 1. FIG. 4A is a plan view illustrating a case where the center line in the longitudinal direction of the hinge portion 8 departs from the center line in the longitudinal direction of the piezoelectric sensor element 20 of the piezoelectric sensor 10 to the left in the drawing. FIG. 4B is a plan view illustrating a case where the center line in the longitudinal direction of the hinge portion 8 is matched with the center line in the longitudinal direction of the piezoelectric sensor element 20. FIG. 4C is a plan view illustrating a case where the center line in the longitudinal direction of the hinge portion 8 departs from the center line in the longitudinal direction of the piezoelectric sensor element 20 to the right in the drawing.

The sensor sensitivity (a degree of variation in frequency when the same force is applied) of the cases shown in FIGS. 4A, 4B, and 4C are simulated using a finite element method. As a result, in the case shown in FIG. 4B, it is confirmed that a stress is uniformly applied to the beams of the frame 12, the stress is concentrated on the center of the hinge portion 8, and the sensor sensitivity is the greatest. In the cases shown in FIGS. 4A and 4C, it is confirmed that the stress applied to the beams of the frame 12 is not uniform, the stress applied to the hinge portion 8 is deviated more to the edges than to the center, and the sensor sensitivity is also reduced.

On the contrary, in Japanese Patent No. 2851566, as shown in FIG. 4 of the publication, a hinge portion (the center line of the hinge) and the center line in the longitudinal direction of a vibrator (double-ended tuning fork type vibrator) are separated from each other and it is thus greatly different from the acceleration sensor according to the invention.

Although it has been described that the shape of the frame 12 formed by the first to fourth beams 12a to 12d is a parallelogram, the shape of the frame 12 is not limited to the parallelogram.

The first beam 12a and the first fixed portion 14a, the second beam 12b and the first fixed portion 14a, the third beam 12c and the second fixed portion 14c, and the fourth beam 12d and the second fixed portion 14c may be formed substantially in an L shape, the first beam 12a and the second beam 12b may be connected in a U shape, and the third beam 12c and the fourth beam 12d may be connected in a U shape.

The first to fourth beams 12a to 12d each may have a circular-arc shape, the first beam 12a and the second beam 12b may be formed in one of a semi-circular shape, a semi-elliptical shape, and a semi-oval shape, and the third beam 12c and the fourth beam 12d may be formed in one of a semi-circular shape, a semi-elliptical shape, and a semi-oval shape.

In any case, it is possible to change the direction of the force applied to the second plate piece by 90 degrees and to enhance the magnitude of the force.

In assembling the acceleration sensor 1, an adhesive 30, for example, a low-melting-point glass having a small residual deformation, is applied to the first fixed portion 14a and the second fixed portion 14c of the piezoelectric sensor 10, and the first fixed portion 14a and the second fixed portion 14c are bonded and fixed to the first support surface 5a and the second support surface 7a of the support plate 4. The resultant is input to a closed container and the inside is made to be in vacuum, thereby constructing the acceleration sensor 1. A weight may be attached to the surface of the second support piece 7 in order to enhance the detection sensitivity of the acceleration sensor 1.

A manufacturing method applying a photolithography technique and an etching technique to a flat-panel piezoelectric plate is known as an example of the method of manufacturing the support plate 4 and the piezoelectric sensor 10. In the piezoelectric sensor 10, electrodes, lead electrodes, pad electrodes, and the like are formed using a vapor deposition method. Examples of the piezoelectric plate include piezoelectric plates formed of crystal, lithium tantalate, lithium niobate, and langasite. For example, when a crystal plate (crystal wafer) is used, the photolithography technique and the etching technique have been used for a long time and the piezoelectric sensor 10 and the support plate 4 with high precision can be easily mass-produced.

When the photolithography technique and the etching technique are used to form the support plate 4 and the piezoelectric sensor 10, it is possible to form the support plate 4 and the piezoelectric sensor 10 with high dimensional precision and to mass-produce acceleration sensor 1 with a small size and at a low cost. Since the frame 12 formed by the first to fourth beams 12a to 12d in the acceleration sensor changes the direction of the force caused by the application of an acceleration by 90 degrees and enhances the magnitude of the force, it is possible to obtain an acceleration sensor which can detect a small acceleration and which has high sensitivity, high precision, and excellent reproducibility.

By forming the first to fourth beams 12a to 12d in a thin band shape with the same width, it is possible to improve the transmission efficiency of the force caused by the application of an acceleration and to detect a small acceleration with good reproducibility.

Since the first plate piece 5, the second plate piece 7, and the hinge portion 8 are formed in a body from the piezoelectric plate by the use of the photolithography technique and the etching technique, it is possible to form the respective elements with high precision and to enhance the detection sensitivity of the acceleration sensor, thereby improving the detection precision. Since the first support surface 5a of the first plate piece 5 and the second support surface 7a of the second plate piece 7 can be easily made to be flush with each other, it is possible to minimize the deformation due to the bonding of the support plate 4 and the piezoelectric sensor 10 and to improve the yield of the acceleration sensor and the reproducibility of the detection precision.

By substantially matching the center in the lateral direction of the piezoelectric element 20 with the center in the lateral direction of the hinge portion 8, it is possible to greatly improve the sensitivity (the variation in frequency of the piezoelectric sensor element when the same acceleration is applied) of the acceleration sensor.

By setting the angle formed by the first beam 12a and the second beam 12b and the angle formed by the third beam 12c and the fourth beam 12d to be obtuse, the angle formed by the first beam 12a and the third beam 12c and the angle formed by the second beam 12b and the fourth beam 12d are acute, thereby changing the direction of the force applied to the second plate piece 7 by 90 degrees and enhancing the magnitude of the force.

Since the first fixed portion and the second fixed portion 14a and 14c are formed to protrude more to the outside of the beams than the intersection of the first and second beams 12a and 12b and the intersection of the third and fourth beams 12c and 12d, it is possible to uniformly transmit the force applied to the second plate piece to the beams.

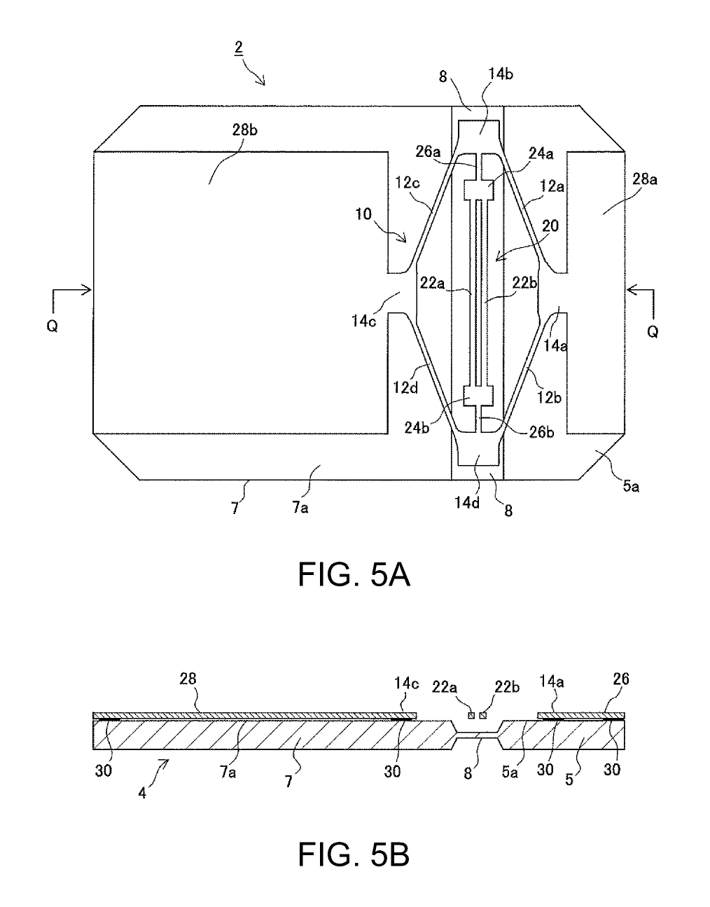

FIGS. 5A and 5B are diagrams illustrating the configuration of an acceleration sensor 2 according to a second embodiment of the invention, where FIG. 5A is a plan view and FIG. 5B is a sectional view taken along line VB-VB. This acceleration sensor is different from the acceleration sensor 1 shown in FIGS. 1A and 1B, in that a first panel-like plate and a second panel-like plate 28a and 28b of a rectangular shape are added to the first fixed portion 14a and the second fixed portion 14c of the piezoelectric sensor 10. The first panel-like plate 28a increases the degree of freedom in connection position of a lead electrode (drawn electrode) extending from the excitation electrode of the piezoelectric sensor element 20, and the second panel-like plate 28b is bonded and fixed to the second plate piece 7 with an adhesive 30, thereby increasing the mass of the second plate piece 7 and improving the sensitivity of the acceleration sensor 2.

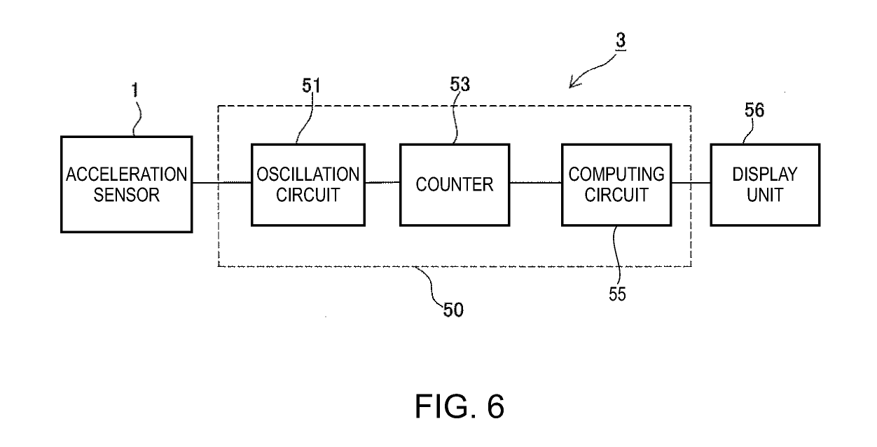

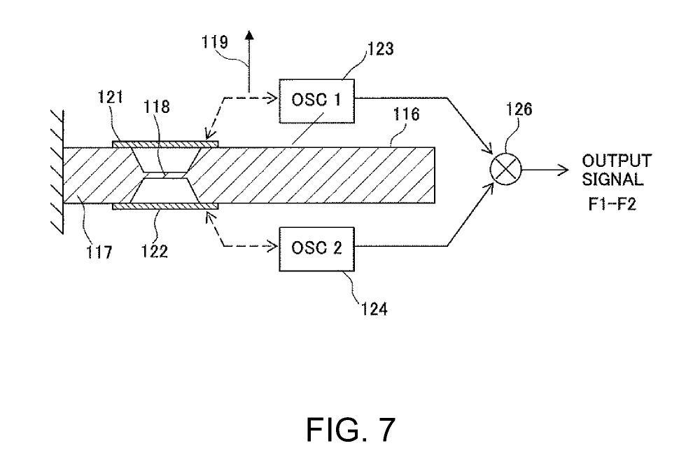

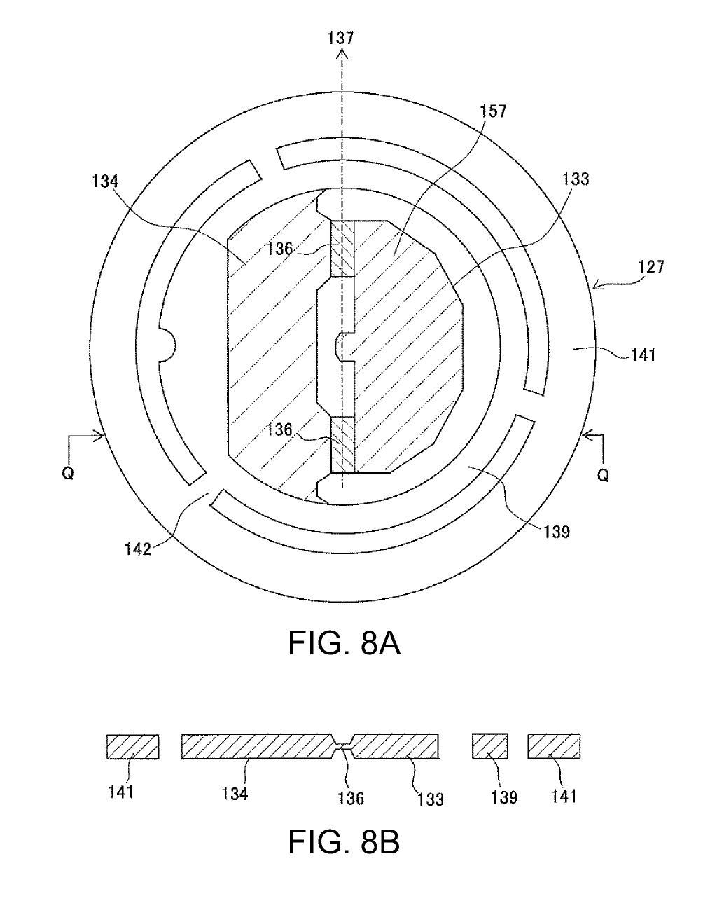

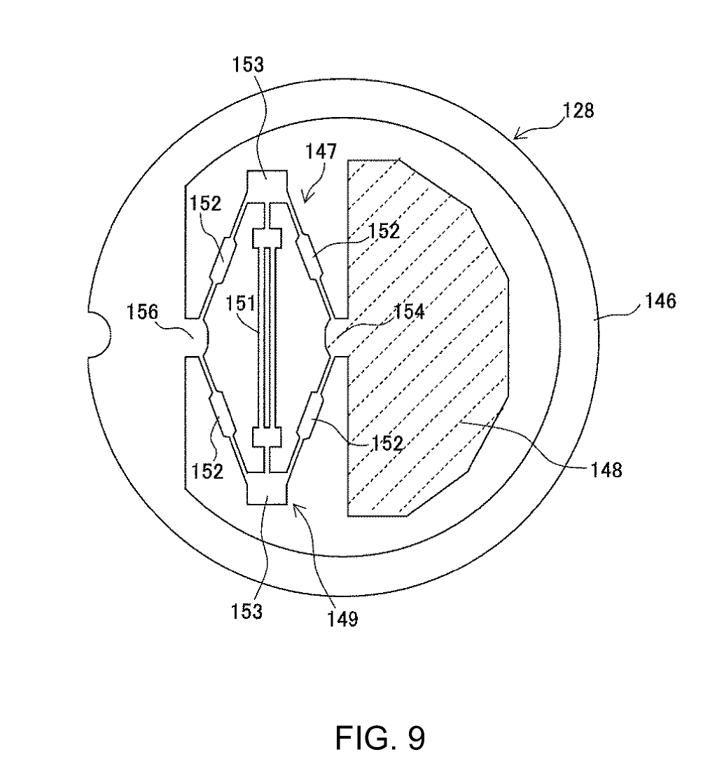

FIG. 6 is a block diagram illustrating the configuration of an acceleration detecting apparatus 3 according to the invention. The acceleration detecting apparatus 3 includes the above-mentioned acceleration sensor 1, an IC 50 including an oscillation circuit 51 exciting the piezoelectric sensor element 20 of the acceleration sensor 1, a counter 53 counting the output frequency of the oscillation circuit 51, and a computing circuit 55 processing the signal of the counter 53, and a display unit 56.

When the support plate 4 and the piezoelectric sensor 10 are formed of a crystal plate, the acceleration sensor is constructed using the double-ended tuning fork type crystal vibrator as the piezoelectric sensor element 20, and the acceleration detecting apparatus is constructed by the acceleration sensor and the IC having the functions, it is possible to greatly improve the acceleration detection sensitivity and to implement an acceleration detecting apparatus with excellent detection precision, reproducibility, temperature characteristic, and aging characteristic.

The entire disclosure of Japanese Patent Application No. 2010-007860, filed Jan. 18, 2010 is expressly incorporated by reference herein.

What is claimed is:

1. An acceleration sensor comprising a piezoelectric sensor and a support plate including a first support surface and a second support surface for supporting the piezoelectric sensor,
wherein the piezoelectric sensor includes a piezoelectric sensor element generating an electrical signal corresponding to a force in a sensing axis direction, a first fixed portion and a second fixed portion fixed to the first support surface and the second support surface, respectively, to support the piezoelectric sensor element on the support plate, and first to fourth beams connecting the piezoelectric sensor element to the first fixed portion and the second fixed portion,
wherein the support plate includes a fixation-side first plate piece having the first support surface for fixing the first fixed portion, a movement-side second plate piece being arranged parallel to the in-plane direction of the first support surface and having the second support surface for supporting the second fixed portion, and a hinge portion connecting opposite side edges of the first plate piece and the second plate piece so as to allow the second plate piece to move in the thickness direction,
wherein the piezoelectric sensor element has a longitudinal shape extending in a direction perpendicular to the sensing axis direction and is separated from the support surfaces in the longitudinal direction of the hinge portion so that the center of the sensor element in the lateral direction is located within the width of the hinge portion in the lateral direction,
wherein the first beam connects the first fixed portion to an end of the piezoelectric sensor element in the longitudinal direction,
wherein the second beam connects the first fixed portion to the other end of the piezoelectric sensor element in the longitudinal direction,
wherein the third beam connects the second fixed portion to an end of the piezoelectric sensor element in the longitudinal direction, and
wherein the fourth beam connects the second fixed portion to the other end of the piezoelectric sensor element in the longitudinal direction.

2. The acceleration sensor according to claim 1, wherein the first to fourth beams each have a thin band shape with the same width all over the length as viewed in a direction perpendicular to the first support surface and the second support surface.

3. The acceleration sensor according to claim 1, wherein the first plate piece, the second plate piece, and the hinge portion are formed in a body and the first support surface of the first plate piece and the second support surface of the second plate piece are flush with each other.

4. The acceleration sensor according to claim 1, wherein the position of the center in the lateral direction of the piezoelectric sensor element is matched with that of the center in the lateral direction of the hinge portion.

5. The acceleration sensor according to claim 1, wherein the first to fourth beams each have a straight line shape, and
wherein an angle formed by the first beam and the second beam in the first fixed portion and an angle formed by the third beam and the fourth beam in the second fixed portion are obtuse angles.

6. The acceleration sensor according to claim 1, wherein the first to fourth beams each have an L shape, and
wherein the first and second beams are connected in a U shape and the third and fourth beams are connected in a U shape.

7. The acceleration sensor according to claim 1, wherein the first to fourth beams each have a circular arc shape, and
wherein the first and second beams are connected in one shape of a semi-circular shape, a semi-elliptical shape, and a semi-oval shape and the third and fourth beams are connected in one shape of a semi-circular shape, a semi-elliptical shape, and a semi-oval shape.

8. The acceleration sensor according to claim 1, wherein at least a part of the first fixed portion protrudes more to the outside from the beams than an intersection of the first and second beams and at least a part of the second fixed portion protrudes more to the outside from the beams than an intersection of the third and fourth beams.

9. An acceleration detecting apparatus comprising:
the acceleration sensor according to claim 1; and
an IC that includes an oscillation circuit exciting the piezoelectric sensor element of the acceleration sensor, a counter counting an output frequency of the oscillation circuit, and a computing circuit processing the signal of the counter.
